(19) United States
(12) Patent Application Publication
(10) Pub. No.: US 2006/0282761 A1
(43) Pub. Date: Dec. 14, 2006

(54) System and method for controlling versions of documents

(75) Inventors: Jeffrey D. Pierce, Sandy Hook, CT (US); Jill Boncek, Bridgeport, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/146,512

(22) Filed: Jun. 7, 2005

(51) Int. Cl. G06F 17/00

(52) U.S. Cl. 715/511

(57) ABSTRACT

A method of generating electronic and/or paper versions of electronic and paper documents that represent the documents contained in a document set, by placing an identification on at least one document in a set of documents that uniquely identifies the set of documents; and placing an identification on each paper document that comprises the set of documents to uniquely identify each document in the set of documents so that one may determine whether or not the document or documents are complete, i.e., they contain all the verbiage and graphics that have been prepared, and no section of a document or document is missing.

### FIELD OF THE INVENTION

This invention relates to methods for managing documents, and more particularly, to methods for controlling versions of documents.

### BACKGROUND OF THE INVENTION

From the invention of paper thousands of years ago to the present date, paper has been used as the preferred medium by individuals and societies for the recording, processing and storage of information. With the introduction of computers into society, many of the functions previously performed exclusively with paper are now being accomplished by typing information into the computer and printing the typed information on paper.

In many business and legal situations, multiple individuals need to collaborate on the creation of a document, which may contain many sections that are prepared and reviewed by different people. The document goes through several cycles of revisions during which a draft is circulated and comments, changes, and other input are sought from the recipients. The recipients may return the document with their comments, or correct the document and create a new version of the document.

Collections of documents or many sections of a document are assembled for purposes such as the submission of a proposal, the acquisition or sale of a business, the closing on large commercial properties, etc. The documents and sections of the documents are often assembled prior to the submission or finalization or closing on the document or documents. Because of the foregoing, the assembled document or documents may not be the final document or set of documents. Thus, someone must review the assembled document or documents to insure that the assembled document/documents are up-to-date. Typically, the paper version of the document or documents is compared with the latest version of the document that is stored in a computer. The foregoing process is a time consuming and error prone process.

### SUMMARY OF THE INVENTION

This invention overcomes the disadvantages of the prior art by providing a system and method that allows one accurately and quickly to determine if the paper document or documents one is viewing is the latest version of the document or documents. The invention also enables one to determine whether or not the document or documents are complete, i.e., they contain all the verbiage and graphics that have been prepared, and no section of a document or document is missing.

This invention accomplishes the foregoing by generating electronic and/or paper versions of electronic and paper documents that represent the documents contained in a document set; by placing an identification on at least one document in a set of documents that uniquely identifies the set of documents; and placing a identification on each paper document that comprises the set of documents to uniquely identify each document in the set of documents so that one may determine whether or not the document or documents are complete, i.e., they contain all the verbiage and graphics that have been prepared and no section of a document or document is missing.

### BRIEF DESCRIPTION OF THE DRAWINGS

FIG. 1 is a drawing of a document;

FIG. 2 is a drawing of a display that displays the documents entered into the system of this invention;

FIG. 3 is a block diagram illustrating the operation of this invention;

FIG. 4 is a flow chart that shows how a document is added to document set 20; and

FIG. 5 is a flow chart that shows how to verify a collection of documents in the document set 20 is complete, and document set 20 is the latest and valid document set.

### DETAILED DESCRIPTION OF THE PREFERRED EMBODIMENT

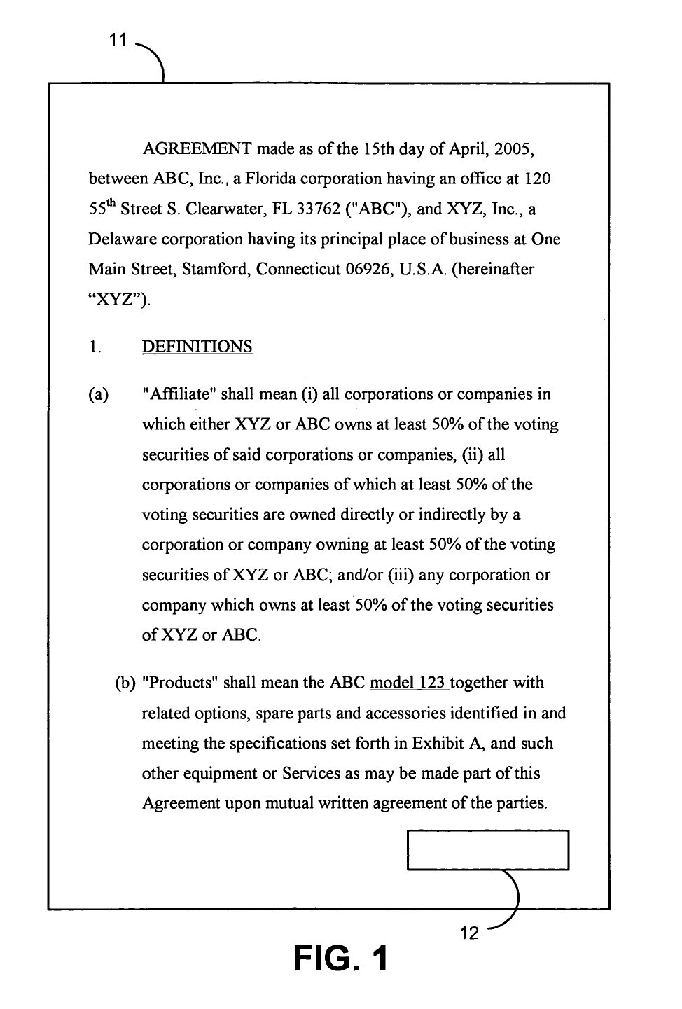

Referring now to the drawings in detail and more particularly to FIG. 1, the reference character 11 represents a document in the form of an original equipment manufacturer agreement. A document identification code 12 is placed at a convenient location on document 11. Identification code 12 may be contained in a radio frequency identification (RFID) tag. Tag 12 may be the UPM RAFSEC EPC1 paper tag manufactured by UPM RAFSEC of 999 Oakmont Plaza Drive, Suite 200, Westmont, Ill. 60559-5563.

Code 12 may also be represented by alphanumeric characters, a bar code, a two-dimensional bar code, glyphs, etc. Code 12 may be printed on document 11 with a black ink, colored ink, toner, invisible ink, black fluorescent ink, etc., or affixed to a label that is attached to document 11. A black fluorescent ink is disclosed in the Auslander et, al U.S. Pat. No. 6,793,723 entitled “Homogeneous Photosensitive Optically Variable Ink Compositions For Ink Jet Printing” herein incorporated by reference.

It would be obvious to one skilled in the art that document 11 may be printed on an Anoto paper page with an Anoto pattern on the paper page that represents a unique map coordinate so that the Anoto pattern will be code 12. Anoto systems use a digital pen that contains a camera and paper in a fashion that the pen's movement across the grid surface on the Anoto paper is stored as a series of map coordinates. The coordinates correspond to the exact location of the page and the exact location of the pen on the page that is being written on. When a mark is made on the send box on the paper with a digital pen, the pen is instructed to send the stored sequence of map coordinates which are translated into an image that will result in an exact copy of what is written on the paper with the pen, which may be stored and displayed in a computer. Anoto systems are sold by Anoto Inc. of 470 Totten Pond Road, Waltham, Mass. 02451

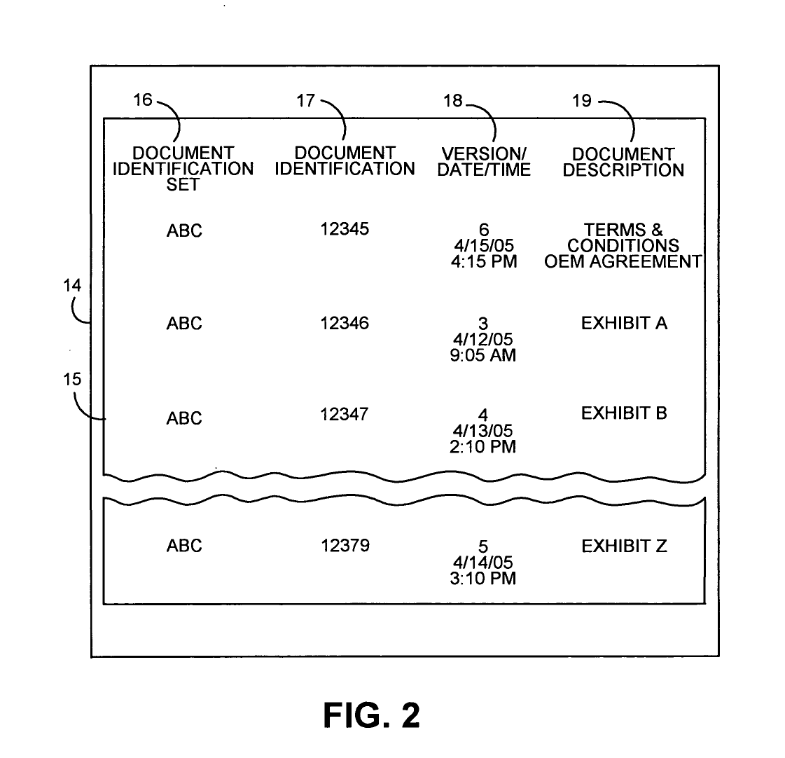

FIG. 2 is a drawing of a display 14 that displays the documents that comprise a document set that are entered into the system of this invention. For instance, document 11 of FIG. 1 is an OEM agreement that contains documents that represent Exhibits A-Z of the OEM agreement. Thus, a document set would be the OEM and the Exhibits A-Z that are going to be attached to the OEM Agreement. It would be obvious to one skilled in the art that each document in the set of documents may be placed in a container that holds the set of documents and identifies the document set. Display 14 has a screen 15 that displays the identification code 12 of FIG. 1 in columns 16 and 17, i.e., the document set and the document identification of a document. Column 18 displays the version of the document and the date and time the document was entered into computer 31, and column 19 indicates the documents description.

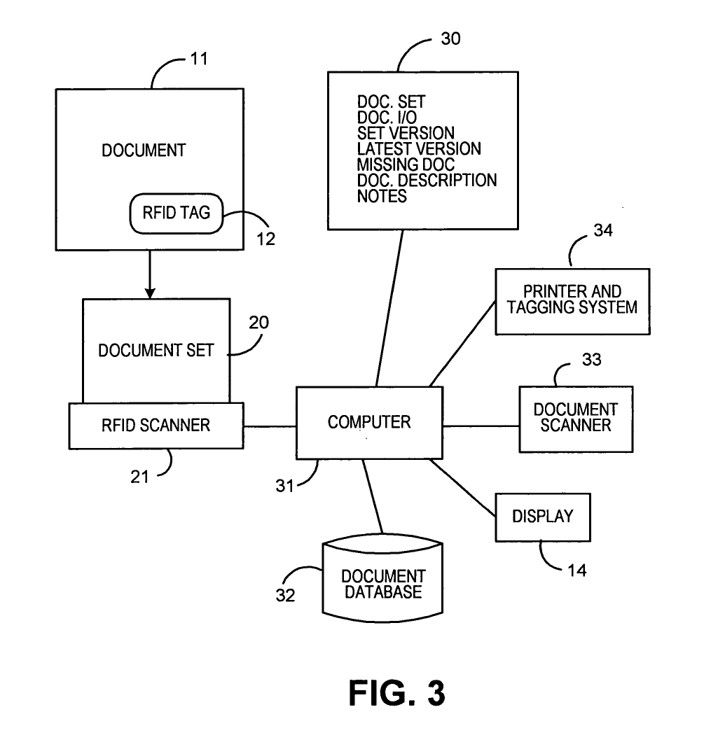

FIG. 3 is a block diagram illustrating the operation of this invention. A user interface 30, i.e., a keyboard, is used to enter information regarding the documents that comprise document set 20 into computer 31. A user may enter the following information into computer 31: the document set, the document identification, the document set version, the latest version of the document, missing documents (documents that have not been prepared), a description of the documents, notes, etc. The information contained in computer 31 will be stored in document database 32, and the foregoing information may be seen on display 14. Document scanner 33 scans paper documents that are stored in computer 31 and subsequently printed as documents of the document set 20 by printer and tagging system 33. Computer 31 also causes printer and tagging system 33 to produce the codes 12 that are attached to the document set 20. Preferably, each code 12 is an RFID tag that is encoded with a unique identifier associated with a document 11 in the document set 20. The RFID tags may be either pre-encoded with a unique identification, or the printing and tagging system 33 may assign a unique identification. In the later case, the unique identification may include descriptive information concerning the document 11. Alternatively, the codes 12 may be bar codes printed either on each document 11 in the document set 20 or on labels affixed to the document set 20. Document set 20 includes document 11 with RFID tag attached hereto and the documents representing Exhibits A-Z (not shown) of the OEM Agreement with their respective RFID tag attached thereto (not shown). A RFID scanner 21 is utilized to read the RFID tags attached to the documents of document set 20. The output of RFID scanner 21 is sent to computer 31 so that a user of this invention will be able to observe information about document set 20 and determine if they have the latest version of document set 20.

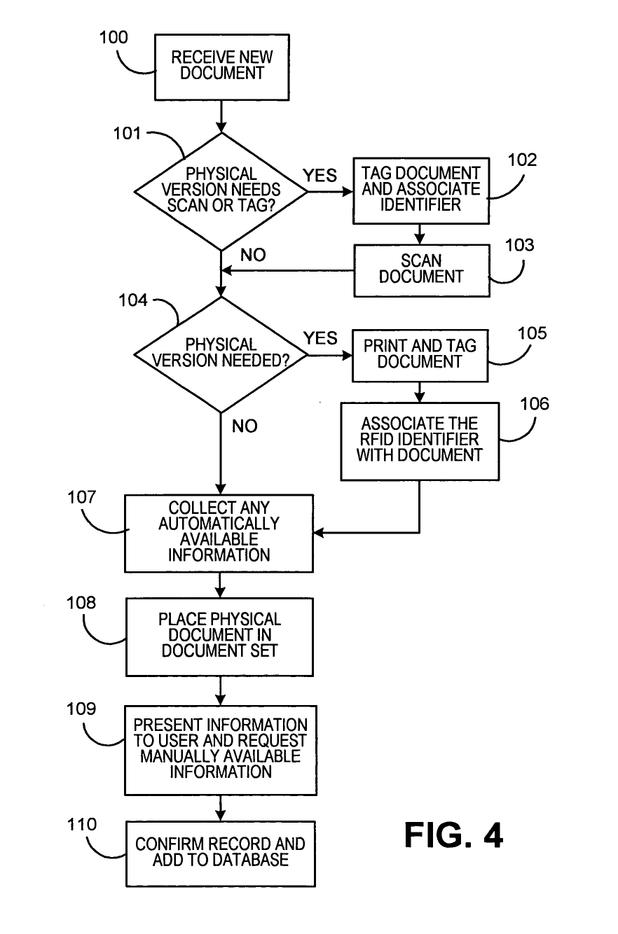

FIG. 4 is a flow chart that shows how a document is added to document set 20. The program begins in block 100, where a new document is received. The program then goes to decision block 101. Block 101 determines whether or not the new document needs a RFID tag. If block 101 determines that the new document needs a RFID tag, the program goes to block 102 where a tag is placed on the document which uniquely identifies the document. Then the program goes to block 103 where the document is scanned. After the document is scanned in step 103 or decision block 101 determines that the new document does not need a RFID tag, the program goes to decision block 104.

At this point, the program goes to decision block 104. Block 104 determines whether or not a physical version of the document is needed. If block 104 determines that a physical version of the document is needed, the program goes to block 105 to print a physical copy on the document and prepare a RFID tag for the document. Then the program goes to block 106 to associate the information in the RFID tag with the document. After the RFID identifier is associated with the document in step 106 or decision block 104 determines that a physical version of the document is not needed, the program goes to block 107. Block 107 collects any automatically available information. Then in block 108, the physical document is placed in document set 20. Now in block 109, the information from the document is presented to the user and manually available information is requested. The manually available information may include the origin of the document, information about the status of the document, or any other information relevant to the application. Then in block 110, the record is confirmed and added to database 32.

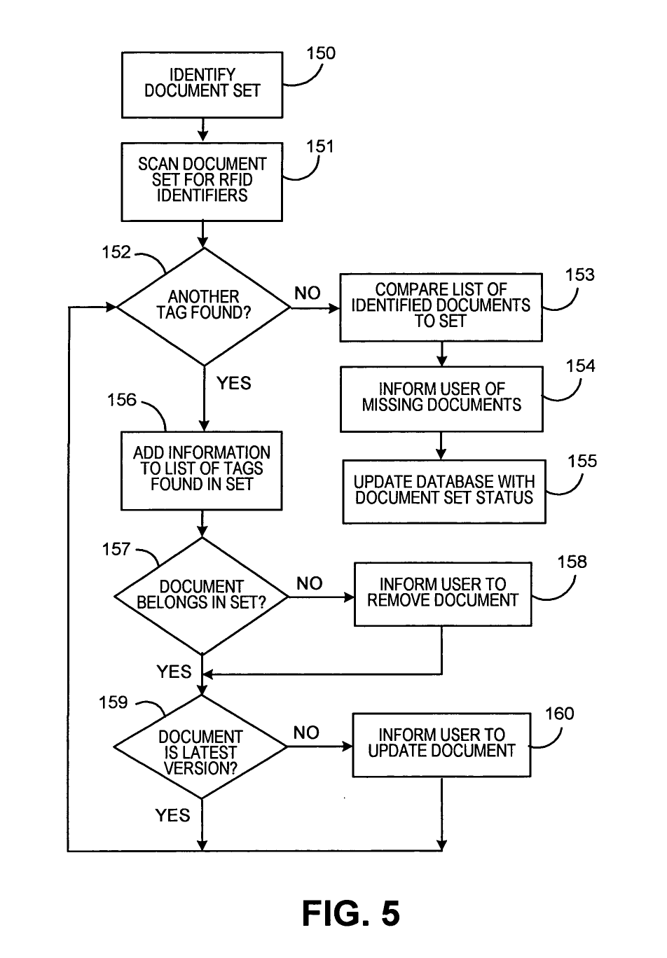

FIG. 5 is a flow chart that shows how to verify that a collection of documents in the document set 20 is complete and that the documents in the document set 20 are the latest, valid versions for the document set. The program begins in block 150, where a document set is identified. Then the program goes to block 151 to scan the document set for RFID identifiers. Now the program then goes to decision block 152. Block 152 determines whether or not the another RFID tag has been found. If block 152 determines that another RFID tag has not been found, the program goes to block 153 to compare the list of identified documents in the set. Then the program goes to block 154 where the user is informed of missing documents. Then the program goes to block 155 to update database 32 with the document set status. If decision block 152 determines that another RFID tag is found, the program goes to block 156 to add information to the list of RFID tags found in the document set.

At this point, the program goes to decision block 157. Block 157 determines whether or not a document belongs in the document set. If block 157 determines that a document does not belong in the document set, the program goes to block 158 to inform the user to remove the document. After the document is removed in step 158 or decision block 157 determines that the document belongs in the document set, the program goes to decision block 159. Block 159 determines whether or not the document is the latest version. If block 159 determines that a document is not the latest version, the program goes to block 160 to inform the user to update the document. If block 159 determines that a document is the latest version, the program goes back to decision block 152.

The above specification describes a new and improved system and method that allows one to accurately and quickly determine if the paper document or documents one is viewing is the latest version of the document or documents. It is realized that the above description may indicate to those skilled in the art additional ways in which the principles of this invention may be used without departing from the spirit. Therefore, it is intended that this invention be limited only by the scope of the appended claims.

What is claimed is:

1. A method for managing documents, which comprises the steps of:
(a) generating electronic and/or paper versions of electronic and paper documents that represent the documents contained in a document set;
(b) placing an identification on each paper document that comprises the set of documents to uniquely identify each document in the set of documents; and
(c) scanning the documents in the document set to determine the documents in the document set.

2. The method claimed in claim 1, further including the step of: placing an identification on at least one document in the set of documents that uniquely identifies the set of documents.

3. The method claimed in claim 2, further including the step of: determining if each scanned document is the latest version of the document.

4. The method claimed in claim 3, further including the step of: determining the time each scanned document was produced.

5. The method claimed in claim 3, further including the step of: determining the date each scanned document was produced.

6. The method claimed in claim 1, wherein the identification information is contained in a radio frequency identification tag.

7. The method claimed in claim 1, wherein the identification information is contained in a code.

8. The method claimed in claim 1, further including the steps of:
(a) associating the identification on a document in the set of documents with the electronic version of the document; and
(b) determining if the electronic version of the document in the set of documents is the same as the paper version of the document.

9. The method claimed in claim 1, further including the steps of:
(a) associating the identification on the set of documents with the electronic version of the set of documents; and
(b) determining if the electronic version of the set of documents is the same as the paper version of the set of documents.

10. The method claimed in claim 1, further including the step of:
placing each document in the set of documents in a container that holds the set of documents and identifies the document set.
